(19) United States
(12) Patent Application Publication
(10) Pub. No.: US 2002/0036040 A1
(43) Pub. Date: Mar. 28, 2002

(54) Tire structure

(76) Inventor: Hsing-Shin Chen, Taichung Hsien (TW)

Correspondence Address: BIRCH STEWART KOLASCH & BIRCH, PO BOX 747, FALLS CHURCH, VA, 22040-0747, US

(21) Appl. No.: 09/963,371

(22) Filed: Sep. 27, 2001

(30) Foreign Application Priority Data
Sep. 27, 2000 (TW) 89216708

(51) Int. Cl. B60C 5/00

(52) U.S. Cl. 152/155

(57) ABSTRACT

A tire structure to provide non-inflatable tires for use in infant strollers or toy vehicles consists of an outer tire layer, an inner tire layer and a tire rim for supporting the outer tire layer and inner tire layer. The inner tire layer is made of uniform foaming materials and is encased in the outer tire layer that is made of rubber. The tire structure is lightweight, has increased resiliency and is cost effective to produce.

### FIELD OF THE INVENTION

The invention relates to a tire structure, and particularly a non-inflatable tire structure that has a solid inner tire layer for use in infant articles such as strollers or toy vehicles.

### BACKGROUND OF THE INVENTION

Commonly used tires now available on the market generally can be categorized as inflatable tires or solid tires. Their characteristics will be briefly described as follows:

Inflatable tires usually have an outer tire layer and an inner tire layer. The outer tire layer is made of rubber and has treads formed on the exterior thereof. The inner tire layer is hollow and may be filled with air. The tire thus constructed has good resilience. However, the inner tire layer has the risk of implosion due to the air filled therein. Moreover, when keeping the tire inflated for a long period of time, the air in the inner tire layer tends to leak, resulting in insufficient tire pressure. Hence users have to inflate the tires frequently, which becomes an annoyance.

There is a tire including a lining ring inside the inflatable tire. In the event of tire implosion, the lining ring can support the weight of the vehicle and allows the vehicle to drive for a certain distance, in order to get the inner tire layer repaired and re-inflate the tire. However, such a structure still has the risks of tire implosion and air leakage after a certain period of time, as conventional inflatable tires do. Also, users still have to check tire pressure frequently and inflate the tires from time to time, which is not convenient.

Solid tires generally include the following types:

1. Integrated Forming Rubber Materials:

These tires are constructed by laminating rubber layers one upon another, then curing and forming in molds at high temperature. The rubber layers have to cover the entire inner tire and thus consume a lot of rubber. The production processes are time consuming and result in higher costs. Moreover, as the entire tire is made of rubber, it becomes quite heavy. These tires have the properties of rigidity and lack of resilience.

2. Integrated Forming EVA Foamed Materials:

These tires are made of uniform EVA foaming materials. As the outer surface is also made of EVA foaming materials, the tire treads tend to wear down rapidly. As a result, the ground traction ability of the tires will decrease and cause safety concerns.

### SUMMARY OF THE INVENTION

The primary object of the invention is to provide a tire structure that has a rubber foaming inner tire layer so that the tire is lighter, more resilient and has a lower production cost. The outer layer of the tire is made of rubber to provide good traction and greater wear resistance.

The tire structure according to the invention includes an outer tire layer, an inner tire layer and a tire rim. The outer tire layer is made of rubber and has an annular hollow interior, which forms a non-closed cross section. The inner tire layer, which is encased in the outer tire layer, is made of rubber and foaming materials that expand evenly under high temperature to become an annular form. The tire rim supports the outer tire layer and the inner tire layer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a perspective view of the invention.

FIG. 3 is a cross section of the invention.

FIG. 4 is a schematic view of a tire rim of the invention.

### DESCRIPTION OF THE PREFERRED EMBODIMENT

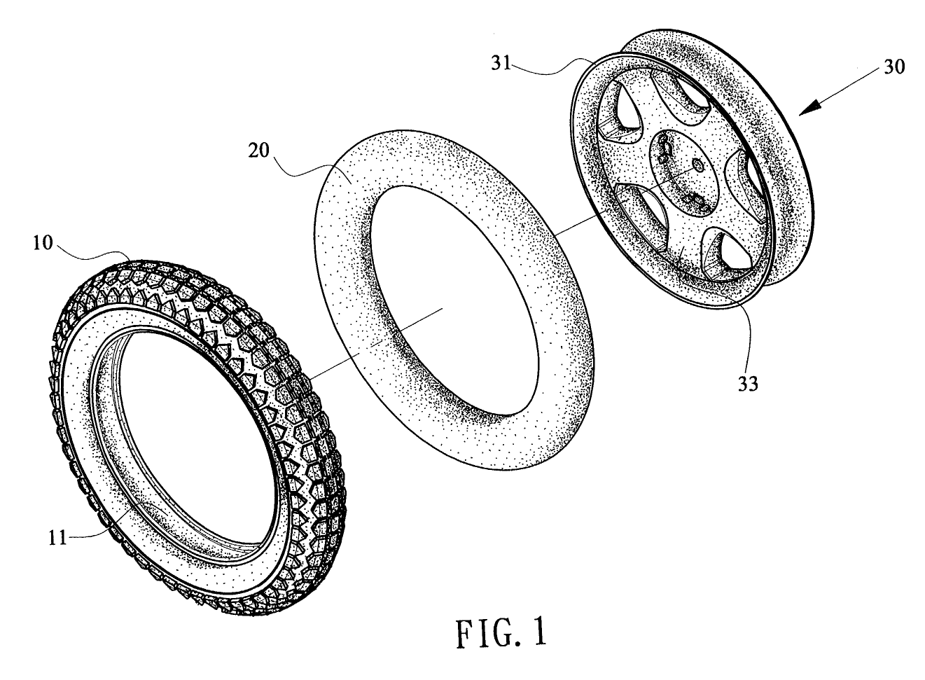

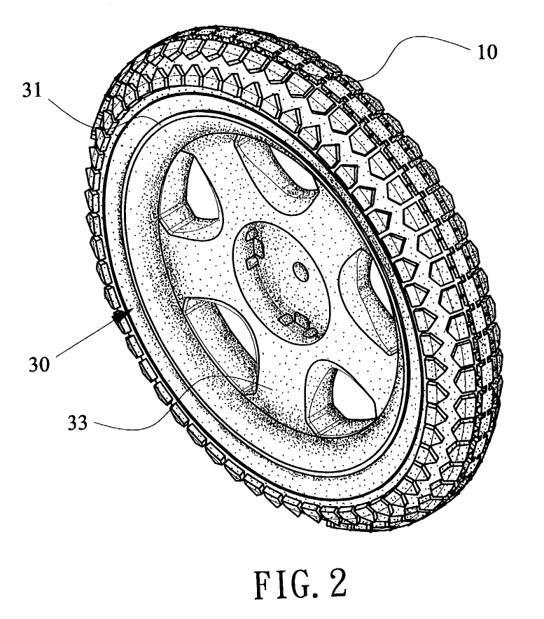

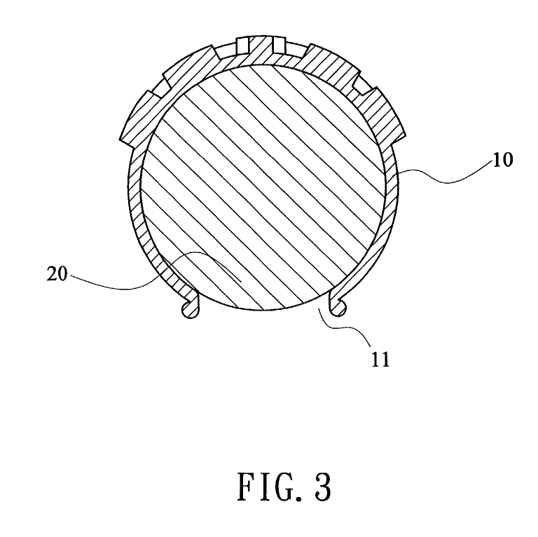

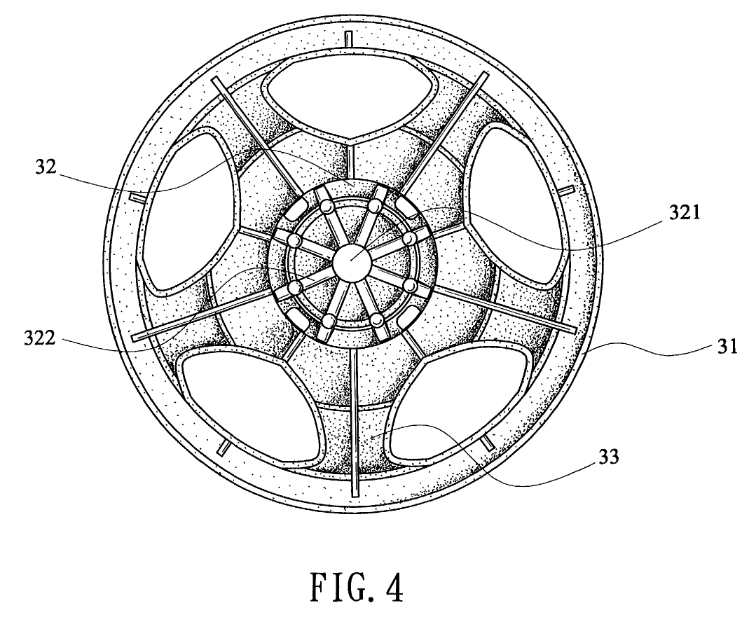

Referring to FIGS. 1 through 4, the tire structure of the invention mainly consists of an outer tire layer 10, an inner tire layer 20 and a tire rim 30. The outer tire layer 10 is made of rubber to form an annular hollow interior. The outer side has treads formed thereon. As rubber has good wear-resistant properties, the treads of the tire thus provide improved traction ability. The outer tire layer 10 has a non-closed cross section with an annular opening 11 formed on the inner periphery. The inner tire layer 20, which is encased in the outer tire layer 10 through an opening 11, is made from rubber and foaming materials that expand evenly under high temperature to become an annular shape. Because of the properties of the inner tire layer 20 materials, the tire as a whole becomes resilient, lightweight and may be produced at a lower cost. The tire rim 30 supports the outer tire layer 10 and the inner tire layer 20, and includes two rim edges 31, an axle hub 32 and a plurality of spokes 33. The rim edges 31 clip two edges of the annular opening 11 to anchor the outer tire layer 10 and the inner tire layer 20. The axle hub 32 has an axle hole 321 to pivotally engage with the axle of the infant articles. At the circumference of the axle hole 321, there is a plurality of latch elements 322 formed radially to fasten the infant article. The axle spokes 33 bridge the axle hub 32 and rim edges 31 to form a plurality of openings therebetween, to reduce the weight of the tire and also to save material consumption and costs.

The tire thus made has the following advantages:

1. Lower Cost.

As the inner tire layer is made from rubber uniform foaming materials that cost much less than rubber, the total production costs for the tire are reduced. The spoke structure allows the tire rim to form openings therein, which can also save material consumption.

2. Lighter Weight.

Since the inner tire layer is made of rubber uniform foaming materials of a lighter weight, and the spoke structure provides the tire rim with openings, the resulting tire is much lighter and can save users effort when carrying the infant articles.

3. Greater Resiliency.

The rubber uniform foaming materials of the inner tire layer allow the tire to have greater resiliency.

4. Reduced Wear.

The outer tire layer is made of rubber and formed with treads. This makes the tire more wear-resistant when riding on rough surfaces.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A tire structure for an infant article that has axles and fastening latches, comprising:
an inner tire layer made from foaming materials and formed in an annular shape;
an outer tire layer made from rubber and formed in a hollow and annular shape with a non-closed cross section to form an annular opening with two edges for encasing the inner tire layer therein; and
a tire rim for supporting the outer tire layer and the inner tire layer, and clipping and sealing the annular opening to anchor the outer tire layer and the inner tire layer.

2. The tire structure of claim 1, wherein the tire rim includes two rim edges, an axle hub and a plurality of spokes, the rim edges being used to clip the edges of the annular opening for anchoring the outer tire layer and the inner tire layer, the axle hub having an axle hole to couple with the axle of the infant article for pivotally fastening the tire structure to the infant article, the circumference of the axle hole having a plurality of latch elements formed radially thereon to engage with the fastening latches of the infant article, the spokes bridging the axle hub and the rim edges.
